(19) United States
(12) Patent Application Publication
(10) Pub. No.: US 2008/0226010 A1
(43) Pub. Date: Sep. 18, 2008

(54) Reactor For Producing Controlled Nuclear Fusion

(76) Inventor: Steven Arnold Sesselmann, New South Wales (AU)

Correspondence Address: BROOKS KUSHMAN P.C., 1000 TOWN CENTER, TWENTY-SECOND FLOOR, SOUTHFIELD, MI, 48075, US

(21) Appl. No.: 12/091,218

(22) PCT Filed: Oct. 16, 2006
(86) PCT No.: PCT/AU06/01526

§ 371 Date: Apr. 23, 2008

(30) Foreign Application Priority Data
Oct. 24, 2005 (AU) 2005905870

(51) Int. Cl. G21B 1/03

(52) U.S. Cl. 376/102

(57) ABSTRACT

Method and apparatus for producing controlled steady state nuclear fusion with isotopes of low atomic numbers being the most useful reactants, such as Deuterium, Tritium and Helium3. The apparatus consists of a high voltage power supply and a high voltage spherical capacitor, constructed in such a way, that the outer shell is the anode and contained centrally within it, a hollow cathode, into which positive ions of the reactant gases can be injected through dielectric tubes and confined electrostatically within the cathode, until such high temperatures are reached, as to allow nuclear fusion to take place. The interior chamber of the cathode forms part of a hermetically sealed fuel circuit running through the capacitor, a turbo molecular pump is also connected in line with the fuel circuit, to drive the reactant gas through the reaction chamber The fusion product, which is mainly high energy Neutrons, Protons and alpha particles, is consequently converted to heat in the dielectric medium contained within the space between the anode and the cathode, this heat can easily be extracted and converted into useful energy using known methods.

### TECHNICAL FIELD

Nuclear fusion, specifically Inertial Electrostatic Fusion

### BACKGROUND ART

The idea of using electrostatic forces to confine the positively charged ions of Deuterium, Tritium or Helium3, goes back to the 1930's, when American inventor Philo Farnsworth invented the Multipactor. Since then Farnsworth and many others, attempted to improve these so called “Fusors”, but with only limited success. Although most of the known devises are capable of nuclear fusion, the ratio of input power to output power is exceedingly small, and non of the devices constructed so far have come close to being viable sources of energy. Current inertial electrostatic fusion devices or “Fusors” rely on a closed sperical vacuum chamber (anode), with a smaller sperical open mesh wire grid cathode in the centre, which is negatively charged with respect to the anode. When the potential voltage difference between the anode and the cathode becomes large enough, some of the Deuterium gas in the chamber becomes ionised, causing the Deuterium nuclei to confine themselves towards the centre of the sphere, where the kinetic energy of the ions cause some nuclei to collide and fuse. Some more advanced designs use ion guns to inject the ions into the centre of the Fusor, and in so doing, increase the efficiency slightly. The limiting factors of these designs are;
That a large amount of input energy is lost as a result of the gas becoming highly conductive at high voltages, causing a leakage of electrons from the cathode grid to the anode chamber walls and
that many of the circulating ions collide with the inner grid (cathode), causing the grid to heat up and break down and
that these before mentioned negative effects increase exponentially as the voltage increases, placing an upper limit on the potential voltage difference between the anode and the cathode.

### RELATED PATENTS

Below are some earlier patents for “Fusor” type reactors;

U.S. Pat. No. 4,894,199—N. Rostoker

U.S. Pat. No. 3,258,402—P. Farnsworth

U.S. Pat. No. 3,386,883—P. Farnsworth

U.S. Pat. No. 3,530,497—R. L. Hirch

U.S. Pat. No. 6,188,746—G. Miley

### Disclosure of Invention

### Technical Problem

To confine nuclei of Deuterium and/or Tritium and/or Helium in a sufficiently small space with sufficiently high kinetic energies, to overcome the known Coulomb forces and undergo nuclear fusion, and in so doing, to extract useful clean energy from the reaction, and this to be achieved as a steady state operation, without the risk of a runaway reaction, which would destroy the apparatus in the process. The most common and easiest fusion reactions to achieve are as follows.

D+D=>T(1.01 MeV)+p(3.02 MeV)

D+D=>He3(0.82 MeV)+n(2.45 MeV)

D+T=>He4(3.5 MeV)+n(14.1 MeV)

D+He3=>He4(3.6 MeV)+p(14.7 MeV)

T+T=>He4+2n+(11.3 MeV)

p+B11=>3He4+(8.7 MeV)

Each of these reactions can potentially release far more energy than the seed energy required to overcome the Coulomb barrier and initiate the fusion process. It is therefore considered that, a devise that can produce controlled nuclear fusion in a steady state, with the input energy being less than the output energy, is the holy grail of energy production. To date, this has not been achieved.

### Technical Solution

Detailed Description of the Apparatus

The subject of this invention is the novel design of the apparatus, which when operated correctly can create a deep electrostatic potential energy well into which ions of Deuterium and/or other elements known to have a low barrier to Fusion, may fall with sufficient energy to overcome the electrical repulsion and breach the Coulomb barrier. In the following example we shall refer to the common D+D reaction, however it should be made clear that this invention is not limited in any way to this reaction. The novel reactor is the key component of this apparatus, and it is constructed from a stainless steel (or similar conducting material) spherical anode shell (3), which is connected to ground potential, in it's centre there is a smaller spherical cathode (1), with a hollow core (23) which is connected by way of a copper rod (9) through a ceramic feed-through (8), to a high voltage negative output DC power supply (10). The cathode (1) is constructed from stainless steel or similar material and has a hollow core (23), into which there are two opposing ceramic tubes (2), which are fitted to the cathode by way of hermetically tight Teflon ferrules and nuts. The ceramic tubes (2) feed through the outer shell (3) on opposite sides, and are sealed tight with ferrules and nuts (25-22). The sealed cavity between the anode and the cathode (5) is filled with dielectric oil through port (6). The dielectric oil serves as electrical insulation between the cathode (1) and the anode (3) and can withstand 100's of kilo volts before breaking down. Other benefits of the dielectric oil (5), during operation, is as a moderator for neutrons and as a heat exchange fluid. The ceramic tubes (2) are connected to the fuel circuit (4) by way of a ceramic to metal pipe union and then to the inlet and outlet of a turbo molecular pump (12), which acts as a fuel reservoir and a method of circulating the fuel through the reaction chamber (23). Also connected to the fuel circuit (4) at (14) is a high vacuum pump (29), which serves to evacuate the fuel circuit (4) to allow for a sufficiently long mean free path for the ions to gain the kinetic energy needed to fuse. A vacuum valve (13) is fitted between the high vacuum pump and the fuel circuit (4) enabling the high vacuum pump to be isolated from the circuit once the desired vacuum has been achieved. A vacuum gauge (18) is connected into the circuit enabling easy reading of the circuit pressure. Connected to the fuel reservoir (12) is the fuel supply line (15) and the slow bleed needle valve (16). The fuel supply line is connected to a supply of pure Deuterium gas.

Detailed Operation of the Apparatus

Safety

Use of this apparatus, must not be attempted by users that do not fully understand the risks and dangers of radiation and electrocution. This apparatus operates with deadly voltages and emits alpha, beta, gamma and neutron radiation. Shielding and monitoring of these particles during operation is essential for health reasons. As the main fuel is Deuterium, which is just another form of Hydrogen, there is also a risk of explosion if the Deuterium is allowed to react with air. Another safety consideration is the potential activation by neutron capture of the materials in the devise itself, which can render the devise slightly radioactive after long term use. Although disposal of such materials can be an issue, it is less of an issue than the current issue of disposing of fission reactor waste, as the half life is in the range of 100 years rather than tens of thousands of years.

Operation

To operate the devise, check that the following devises are correctly connected and that all valves are closed. An adjustable high voltage DC power supply (10), adjustable from 0 to 150 KV is connected, chassis to ground and the negative output to the cathode (9). A high purity source of Deuterium gas connected at (15) A high vacuum diffusion pump (29) or alternatively a turbo molecular pump with roughing pump, connected at (14) Check that all metal components, except the cathode, but including the fuel circuit, and the pumps are firmly connected to ground. Start by evacuating the air in the fuel circuit to a high vacuum, by first opening the valve (13) and then starting the roughing pump, when the vacuum gauge reaches around 10e-2 torr, the oil diffusion pump can be activated, lowering the pressure further to 10e-4 torr or a high vacuum. Once a high vacuum has been achieved in the fuel circuit, the circulation pump (12) can be activated. Once the circulation turbo pump has reached operating speed, a small amount of Deuterium gas can be admitted into the circuit through the needle valve at (16). Once the pressure has stabilized at around 10e-3 Torr the DC power supply can be turned on, and the voltage between the cathode (1) and the outer shell (3) can slowly be increased, until a steady state fusion reaction takes place. Circuit pressure and voltage will need adjusting for optimum performance. Confirmation that fusion is talking place, can be made by measuring the neutron flux adjacent to the devise, using standard neutron detection equipment. During operation Excess heat may be produced, and can be extracted, by connecting an external heat exchange circuit to ports (6) and (7) and pumping dielectric oil through the outer chamber (5) via the circuit. To shut down the devise, follow the above steps in reverse order.

Theory of Operation

The apparatus as described above operates by circulating Deuterium gas through a circuit, which in it, has a deep potential energy well at the reactor core, relative to the rest of the circuit, which is at ground potential. The rarefied gas of Deuterium is circulated through the reactor circuit by way of a mechanical turbo molecular pump. When the neutral atoms of Deuterium reach the ceramic feed-through (2) to the reaction chamber (23) the extreme voltage potential between the cathode (1) and the outer circuit, which is grounded, will cause some of the Deuterium atoms to ionise. Once a Deuterium atom becomes ionised, the positively charged ion will be accelerated towards the cathode, and the electron will be accelerated towards ground. The accelerating ion may collide with other Deuterium atoms on its path towards the cathode, causing a cascade of ions, that follow the same route, thereby turning some of the gas into a plasma. By the time the positive ions reach the hollow reaction chamber inside the cathode, they become trapped at the bottom of the potential energy well (see diagrams FIG. 4-26), and will not escape unless they pick up a stray electron and become neutral. Any neutral atoms are soon evacuated from the reaction chamber by the turbo molecular pump (12). The build up of positive ions inside the cathode chamber cause a small but relative positive potential inside the cathode see (FIG. 4-26). The density of Deuterium ions in the reaction chamber, eventually reach a point where collisions between suspended and incoming ions exceed the Coulomb barrier and cause some ions to fuse. At this point during the D+D reaction, the newly formed Tritium or Helium3 nuclei cause a massive potential energy drop in the reaction chamber. This in turn, creates a virtual potential energy hole (FIG. 5-27), into which other Deuterium atoms can fall, causing further widening and deepening of the hole. (This hole has also been referred to as a virtual cathode, by Philo Farnsworth). The potential energy gap between the outer surface of the cathode, and the potential energy hole inside the reaction chamber, can be lowered, simply by increasing the voltage potential between the cathode and the anode (see diagrams FIG. 3 to 7), allowing for a controlled steady state fusion reaction. The products of the D+D reaction are Tritium and He3 in proportion roughly 50/50 and a fast neutron or proton depending on the reaction. In the event D+D=>He3, a fast neutron is produced. As the neutron does not have an electrical charge, it easily escapes the reaction chamber (1) and travels through the dielectric oil (5), which is an excellent moderator for neutrons, causing the neutron to give up most of its kinetic energy as heat to the oil. In the other event, that D+D=>T, a fast proton is produced. Such a proton is unable to escape the reaction chamber, and will most likely become embedded on the inside surface of the cathode (1), thereby giving up it's kinetic energy to the cathode and contributing to further ionisation in the reaction chamber. The fusion products Helium3 and Tritium remain in the fuel circuit and may contribute further to the fusion process in any of the following reactions.

D+T=>He4(3.5 MeV)+n(14.1 MeV)

D+He3=>He4(3.6 MeV)+p(14.7 MeV)

T+T=>He4+2n+(11.3 MeV)

The above secondary reactions are all more energetic than the primary D+D reaction and consequently it is expected that these reactions will contribute significantly to the power output of the devise, as the pure Deuterium fuel gradually converts to Tritium and He3.

### Advantageous Effects

The advantage of this invention over the existing inertial electrostatic fusion devises, lies in the novel design of the cathode reaction chamber. By enclosing the catode reaction chamber and electrically insulating it from the surrounding anode, it has for the first time become possible to increase the voltage potential between the anode and the cathode, almost without limits, and in so doing, the negative effects of electrons streaming from the cathode to the anode has virtually been eliminated. This invention has also solved the problem, where the wire grid anode in existing inertial electrostatic fusion devises, heat up and break down due to the continous collisions of ions with the catode. This invention has also provided a way to moderate the fast neutrons directly at the source and convert the neutrons kinetic energy into heat, as well as a way to extract this heat and at the same time kepping the reactor core cool.

### DESCRIPTION OF DRAWINGS

FIG. 1

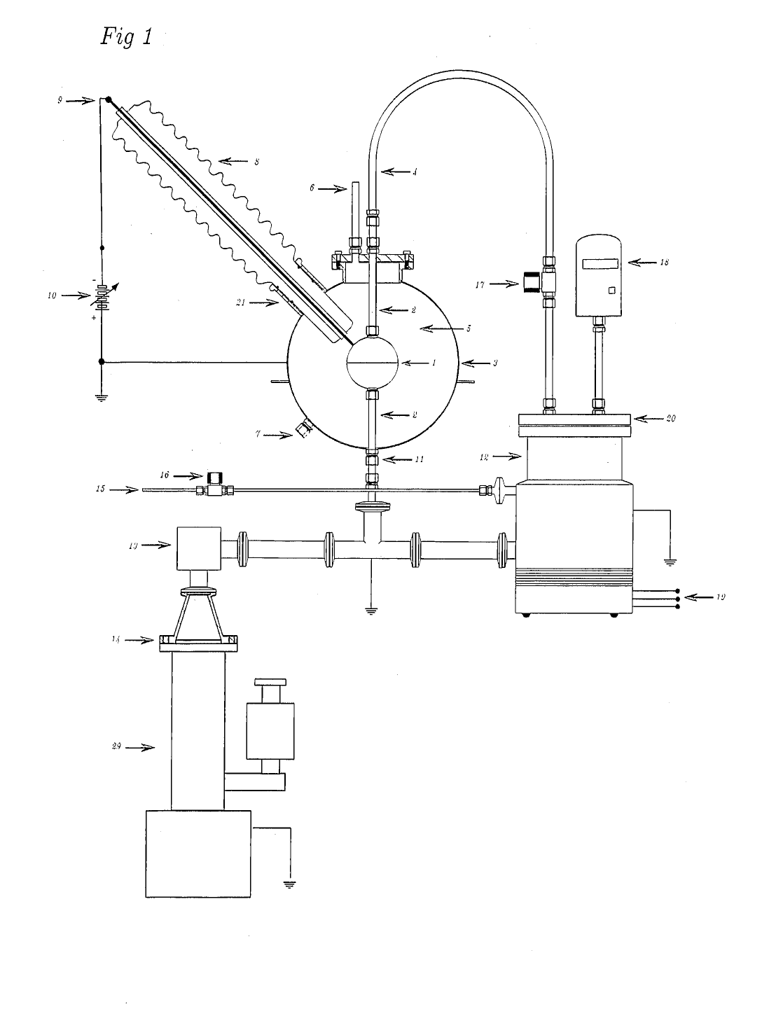

Diagram of reactor and fuel cirquit.

FIG. 2

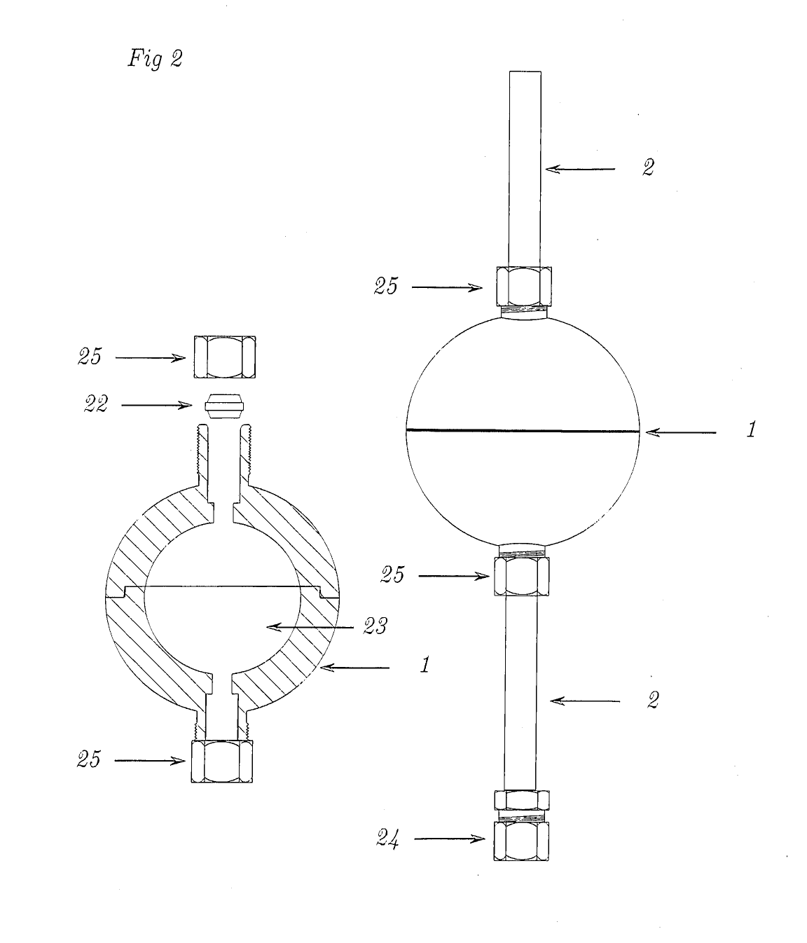

Diagram of reactor core (cathode) and section of the same.

FIG. 3 to 7

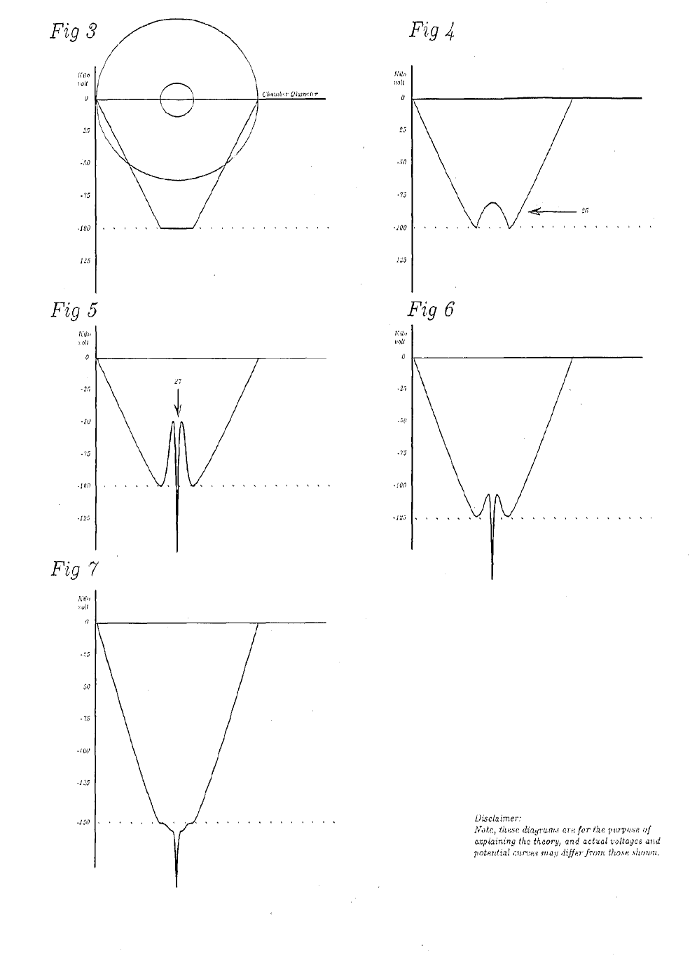

The attached diagrams FIG. 3 to 7 are schematic diagrams showing the theoretical potential energy in relation to fusion reactor cross section (X axis) and input voltage (Y axis). FIG. 3 shows the potential energy curve against the outline of the reactor anode and cathode at a −100 kv with no ionisation in the reactor chamber. FIG. 4 shows the same curve after a small build up of positive ions in the reaction chamber. FIG. 5 shows the formation of a virtual cathode, created by the fusion of nuclei. FIG. 6 shows how the barrier to fusion is lowered as the voltage potential difference is increased. FIG. 7 shows a hypothetical situation where the potential energy barrier to fusion has almost been eliminated and where ions fall straight through to a fused state.

### DIMENSIONS

The dimensions and descriptions for the prototype devise in the attached diagram are as follows;

(1) Stainless steel cathode outside diameter 60 mm with 40 mm inside cavity diameter.

(2) 8 mm outside diameter 5 mm inside diameter high alumina ceramic tube.

(3) Stainless steel sphere 200 mm diameter

(4) 8 mm Stainless steel tube

(5) Cavity filled with dielectric oil

(6) Dielectric fluid inlet

(7) Dielectric fluid outlet

(8) 370 mm Ceramic insulator with hollow core

(9) 3 mm copper conductor

(10) High voltage DC power supply

(11) Fuel inlet

(12) Turbo molecular pump

(13) Vacuum valve

(14) Connection to high vacuum pump

(15) Connection to Deuterium gas supply

(16) Slow leak needle valve

(17) Circuit isolation valve

(18) Vacuum gauge

(19) Connection to turbo pump controller

(20) Blank flange

(21) Rubber “O” ring seals

(22) Teflon ferrule

(23) Cathode reaction chamber

(24) Nut and ferrule union

(25) Nut and ferrule

### INDUSTRIAL APPLICABILITY

The primary uses of the said devise is the conversion of nuclear fusion energy into heat, which in turn can be converted into useful energy by known methods. It is believed that this devise can be scaled up or scaled down depending on its intended use. Due to the relatively safe operation and safe fuel requirements, it could easily be operated in urban areas without the dangers of transporting hasardous fuel, providing that adequate neutron shielding is built around the reactor core itself.

The secondary use of the said devise is as a neutron source. Neutron sources are used in many industries including mining and medicine and the said invention can easily be adapted to smaller portable units for use in these industries.

1. Apparatus for producing steady state nuclear fusion, by means of a strong spherical electrostatic field, into which particles of fusion reactive fuel may be guided through a system of conductive and dielectric tubes, once inside the said field, some of the particles may become ionised by natural means, and consequently accelerated towards the central region of the said field, where further collisions and ionisation of particles take place, due to the electrostatic field gradient, ionised particles are unable to escape the said field, and are therefore confined in the central region of the said field, where the ion density rapidly increases to a point where there is a high probability that the said ions collide and fuse, the fusion process consequently releases energy in the form of a fast moving proton, a fast moving neutron or a fast moving alpha particle depending on the specific reaction, those reactions that produce a charged particle will contribute to the ionisation of further particles, and in so doing, fuelling the process further, the thermal energy generated from the nuclear fusion reactions may consequently be converted into useful energy by known methods, and the neutrons emitted may be used in medicine, science or industry, the apparatus comprising;
a. a spherical capacitor constructed in such a way that the anode is essentially a hollow sphere and surrounds the cathode, the cathode which is a hollow sphere of smaller diameter than the anode
b. a solid or liquid dielectric (example: transformer oil) that completely fills the space between the anode and the cathode
c. an electrical circuit and electrical bushing or feed through, fitted through the anode wall so as to allow a high voltage DC current to negatively charge the cathode to a strong electric potential with respect to the anode, the anode which is maintained at ground potential
d. a hermetically sealed fuel circuit comprising, the cathode, part quarts, ceramic or similar dielectric tubing, part conductive metal tubing, and a means of circulating the fuel through the circuit, where a section of the said circuit runs through the centre of the said spherical capacitor in such a way as to incorporate the said cathode into the circuit, the dielectric tube sections forming those parts of the said circuit which bridge the dielectric gap between the anode and the cathode
e. a means of evacuating the fuel circuit to sufficiently low pressures, so as to allow the ions to have a mean free path long enough to allow fusion reactive energies to be reached
f. a fuel inlet valve connected in such a way as to allow fusion reactive gases to be administered into the fuel circuit in a controlled way

2. a device and method as in claim 1, where the anode is insulated from the cathode by way of dielectric oil and/or ceramics and/or vacuum and/or any other dielectric material

3. a device and method as in claim 1, where a dielectric fluid insulating the said anode from the said cathode also functions as a neutron moderator

4. a device and method as in claim 1, where a dielectric fluid insulating the said anode from the said cathode also functions as a heat exchange fluid

5. a device and method as in claim 1, where any number of dielectric tubes feed from the exterior of an anode, to the interior of a hollow cathode

6. a device and method as in claim 1, where a turbo molecular pump is used to circulate the reactant gas through the cathode

7. a device and method as in claim 1, where the main fuel is Deuterium

8. a device and method as in claim 1, where the main fuel is Tritium

9. a device and method as in claim 1, where the main fuel is Helium3

10. a device and method as in claim 1, where the main fuel is Boron11

11. a device and method as in claim 1, where the fuel is a mixture of the gases in claim 7, 8, 9 and 10

12. a device and method as in claim 1, where the primary use is to produce heat

13. a device and method as in claim 1, where the primary use is to produce neutrons

14. a device and method as in claim 1, where the said anode is made from wire mesh and where the said capacitor is submerged in a pool of dielectric fluid.

15. a device and method as in claim 1, where the shape of the said anode and the shape of the said cathode are of a shape other than spherical

16. a device and method as in claim 1, where multiple reactors are connected in series

17. a device and method as in claim 1, where multiple reactors are connected in parallel
